(19) United States
(12) Patent Application Publication
(10) Pub. No.: US 2008/0288452 A1
(43) Pub. Date: Nov. 20, 2008

(54) SERVICE USING REFERRER STRINGS TO IMPROVE ADVERTISEMENT TARGETING

(75) Inventors: Pasha Sadri, Menlo Park, CA (US); Daniel Joseph Raffel, San Francisco, CA (US); Jonathan James Trevor, Santa Clara, CA (US); Edward Ho, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/748,845

(22) Filed: May 15, 2007

(51) Int. Cl. G06F 17/30

(52) U.S. Cl. 707/3; 707/E17.108

(57) ABSTRACT

Query information in an indication of a referral to a web page is used to characterize the web page, e.g., for targeting advertisements and/or other supplemental content to display in association with the web page or in the process of responding to subsequent search engine queries. A referral indication may be provided by the publisher web page, indicating a referral from a search engine service to the publisher web page based on an activation of one of a plurality of search results. The referral indication, and sometimes other information as well, is processed to cause determination therefrom of characteristics of the publisher web page. Thus, for example, based at least in part on the determined characteristics, supplemental content may be determined to be displayed in association with the content of the publisher web page. In addition, the determined characteristics may be used by a search engine service in the process of responding to search queries.

### BACKGROUND

It is known to display supplemental content, such as advertisements, on a published web page. As just one example, the Yahoo! Publisher Network is a service provided by Yahoo! Inc. of Sunnyvale, Calif., to enable web page publishers to have contextually-relevant advertisements displayed on their published web page. The web page publishers receive a portion of revenue generated by the advertisements (e.g., as a result of an advertisement being “clicked”).

The advertisements are typically determined as a result of a “crawling” process. During the crawling process, the published content of the web page is analyzed. As a result of the analysis, one or more advertisements from an inventory of advertisements is matched to the published content of the web page. When the web page is subsequently viewed, the advertisements determined as a result of the analysis are displayed in association with the published content of the web page.

### SUMMARY

In accordance with an aspect, query information in an indication of a referral to a web page is used to characterize the web page, e.g., for targeting advertisements and/or other supplemental content to display in association with the web page. Thus, for example, a referral indication may be provided by the publisher web page, wherein the referral indication is an indication of a referral from a search engine service to the publisher web page based on an activation of one of a plurality of search results. The referral indication includes an indication of a query processed by the search engine service and to which the plurality of search results are responsive. The referral indication provided by the publisher web page, and sometimes other information as well, is processed to cause determination therefrom of characteristics of the publisher web page. Based at least in part on the determined characteristics of the publisher web page, supplemental content is determined to be displayed in association with the content of the publisher web page and providing an indication of the determined supplemental content to display.

### BRIEF DESCRIPTION OF THE DRAWINGS

FIG. 1 illustrates an architecture of a system in which a search engine query resulting in viewing of a web page (i.e., an activated one of a plurality of search results based on the search engine query) is provided as input for determining characteristics of the publisher web page.

FIG. 2 is a flowchart generally illustrating an example of processing in the FIG. 1 system.

FIG. 3 is a simplified diagram of a network environment in which specific embodiments of the present invention may be implemented.

### DETAILED DESCRIPTION

The inventors have realized that a search engine query that results in a user viewing a particular publisher web page provides information about that publisher web page that can be valuable for targeting advertisements to viewers of that publisher web page.

In accordance with an aspect, the publisher web page receives an indication of a referral from a search engine service based on an activation of one of a plurality of search results. More particularly, the indication of the referral includes an indication of a query processed by the search engine service and to which the plurality of search results are responsive. Processing of the web page causes the received referral indication to be processed at least by causing the query indication to be provided to a system external to the publisher web page, such as to an analyzer for determining characteristics of the publisher web page. Thus, for example, the determined characteristics of the publisher web page are usable for determining supplemental content (such as advertisements) to display in association with the web page content. Another use of the determined characteristics may be as input to a search engine.

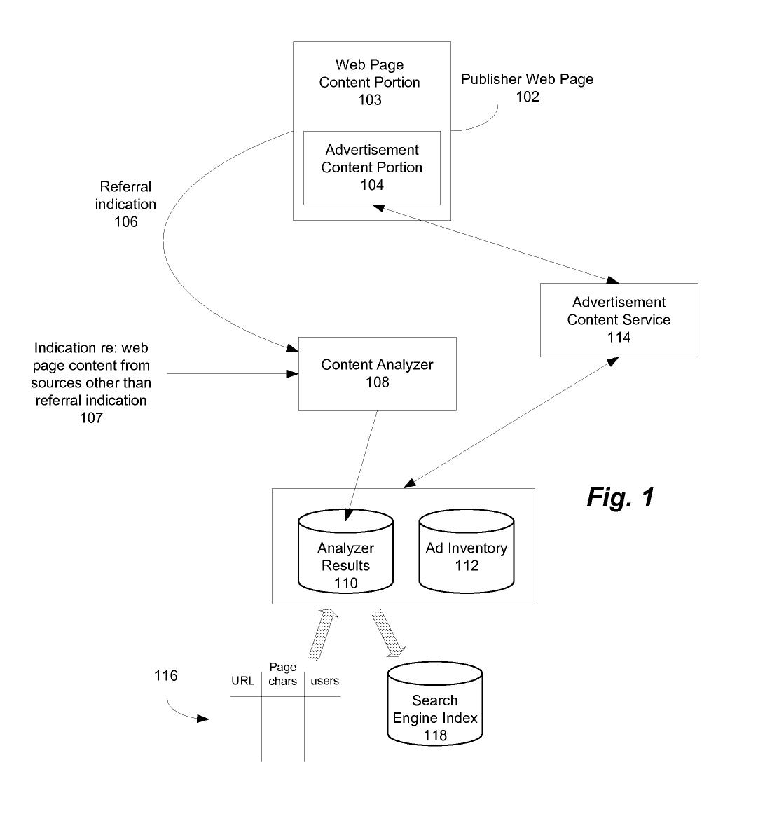

FIG. 1 illustrates an architecture of a system in which a search engine query resulting in viewing of a web page (i.e., an activated one of a plurality of search results based on the search engine query) is provided as input for determining characteristics of the publisher web page. As shown in FIG. 1, a publisher web page 102 (as rendered and displayed) includes a web page content portion 103 and an advertisement content portion 104. Advertisement content, caused to be displayed in the advertisement content portion 104, is provided from an advertisement content service 114. When the publisher web page 102 is caused to be displayed, the published content of the publisher web page 102 is caused to be displayed in the web page content portion 103, and the associated advertisement content is caused to be displayed in the advertisement content portion 104.

More particularly, the associated advertisement content caused to be displayed in the advertisement content portion 104 is determined by an advertisement content service 114 based on analyzer results 110 and on ad inventory 112. The analyzer results 110 are a result of a content analyzer 108 analyzing at least a search engine referral indication to the publisher web page 102. Other indications 107 of characteristics of the publisher web page 102 may be analyzed as well by the content analyzer 108.

The analyzer results 110 may include, for example, data 116 organized by URL (of various publisher web pages, including the publisher web page 102), page characteristics and users. The users may be, for example, users who interacted with a search engine to cause a search engine referral indication 106 to be sent to the content analyzer 108. Search engine referral indications (or a result of processing the search engine referral indications) may, as part of the analyzer results 110, be associated with particular users.

The advertisement content service 114 may determine what advertisements to cause to be displayed in the advertisement content portion 104 of the publisher web page 102 based at least in part on the particular user requesting display of the publisher web page 102. In fact, if the display request is result of a search engine referral, the search engine referral indication 106 may be used in determining the contents of the advertisement content portion of the publisher web page in fulfillment of that request generally. Furthermore, the user information may be used in determining the contents of the advertisement content portion of the publisher web page in fulfillment of future requests for that publisher web page by the user. Yet further still, the user information may be used in determining the contents of the advertisement content portion of the publisher web page in fulfillment of future requests for that publisher page by other users that have some discernible relationship to the user who accessed the search engine service to eventually reach the publisher web page.

It is noted that, in some examples, the publisher web page receives the search engine referral indication as part of the HTTP request for the publisher web page sent by the user's browser. See, for example, section 14.36 of RFC 2616 of The Internet Engineering Task Force, June 1999. The referral indication may be captured and provided to the content analyzer 108 using, for example, active code such as Javascript or ActiveX code that has been incorporated into script of the publisher web page.

In one example use of the FIG. 1 system, a user accesses the Google search engine service and provides the following query—“dyson vacuum cleaner.” The Google search engine service provides a plurality of listings in response to the search query. The user activates one of the listings, which causes the web page content portion of the publisher web page (corresponding to the activated listing) to be displayed.

Furthermore, the user's browser (e.g., based on active script included as part of the publisher web page source code) also causes the referral indication, from the Google search engine service to the publisher web page, to be provided to the content analyzer. For example, the referral indication may include the following string: http://www.google.com/search?hl-en&lr=&q=dyson+vacuum+cleaner. Using at least the referral indication, the content analyzer generates the analyzer results.

In addition, the browser requests, from the advertisement content service, advertisement content to be displayed in the advertisement content portion of the publisher web page. The advertisement content service, based on the analyzer results and the ad inventory, provides to the browser an indication of an advertisement to display in the advertisement content portion of the publisher web page.

In some examples, the analyzer results 110 may be at least a portion of data, such as a search engine index 118, used by a search engine to generate responses to subsequent queries.

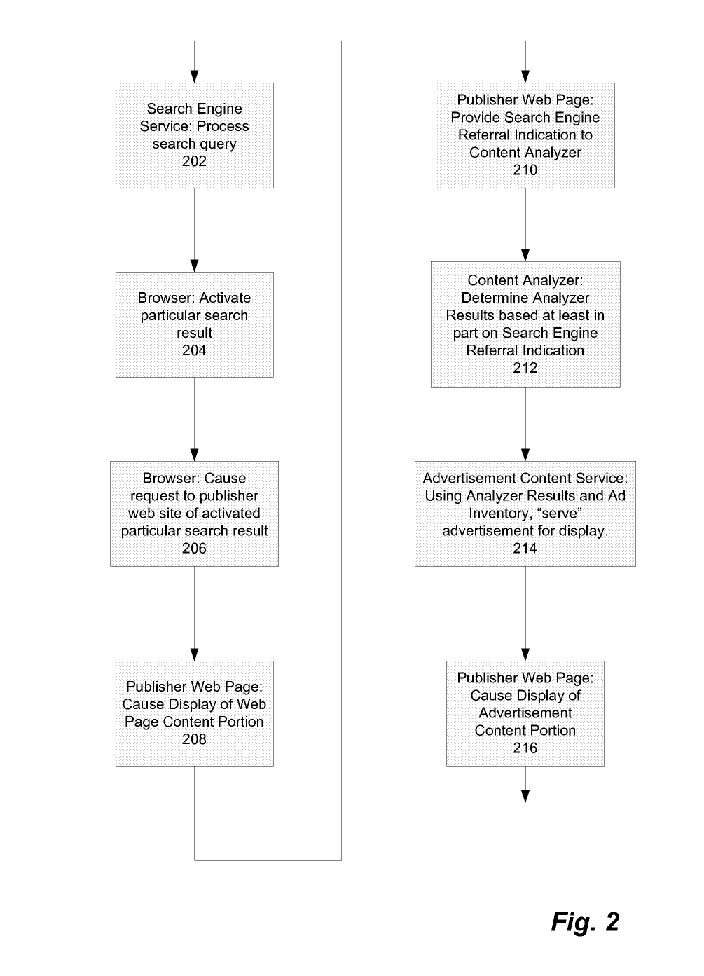

FIG. 2 is a flowchart generally illustrating an example of processing in the FIG. 1 system. At step 202, a search engine service processes a search query including, for example, generating a list of search results for display by a browser program of a user. The search results correspond to web pages and include a mechanism such that, when a particular search result is activated (step 204), based on action by a user via a browser, the user's browser causes a request (step 206) for display to the web site of the web page to which the activated result corresponds. The request includes a referral indication that provides some indication of the search query, such as the keywords of the search query.

At step 208, the web site causes display of the content portion of the web page. At step 210, the web site provides the search engine referral indication to a content analyzer. The search engine referral indication provided to the content analyzer may be modified as to form, but includes substantially the same or similar information as the search engine referral indication provided by the browser as part of the display request, at least with respect to the search query.

At step 212, the content analyzer determines analyzer results based at least in part on the search engine referral indication. At step 214, the advertisement content service uses the analyzer results (which may have been determined in consideration of information in addition to the search engine referral indication) to serve an advertisement for display in an advertisement content portion of the web page. At step 216, the browser causes display of the advertisement in an advertisement content portion of the web page.

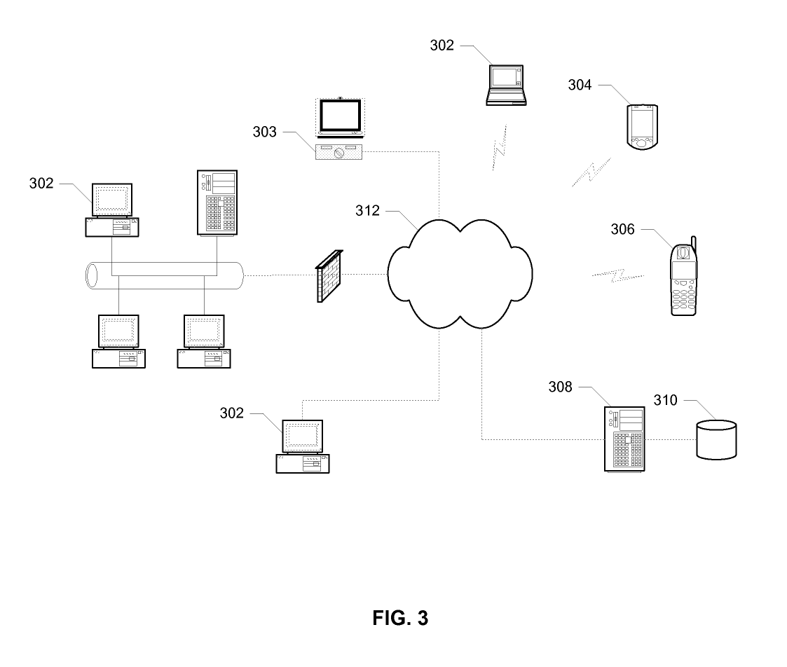

Embodiments of the present invention may be employed to facilitate, in any of a wide variety of computing contexts, providing advertising relevant to search queries, with the display of web pages that are a target of the search. For example, as illustrates in FIG. 3, implementations are contemplated in which the search query entry and display activities are carried out by a population of users interacting with a diverse network environment via any type of computer (e.g., desktop, laptop, tablet, etc.) 302, media computing platforms 303 (e.g., cable and satellite set top boxes and digital video recorders), handheld computing devices (e.g., PDAs) 304, cell phones 306, or any other type of computing platform.

According to various embodiments, the sender referral indication may be provided and processed using a wide variety of techniques. For example, providing the referral indications may be accomplished by transmitting data between computing devices. Once transmitted, these data may be processed in order to facility characterizing the publisher web site in a centralized manner. This is represented in FIG. 3 by the server 308 and the data store 310 which, as will be understood, may correspond to multiple distributed devices and data stores.

The various aspects may also be practiced in a wide variety of network environments (represented by network 312) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

We have thus described a system and method in which a search engine query that results in a user viewing a particular publisher web page provides information about that publisher web page for determining characteristics of that publisher web page. Thus, for example, the determined characteristics may be used to target advertisements or other supplemental content to viewers of that publisher web page or may be used by a search engine service in the process of responding to search queries. The publisher web page receives an indication of a referral from the search engine service, which is then provided to an analyzer to be considered in determining characteristics of the publisher web page.

What is claimed is:

1. A method of operating a publisher web site, including at least one publisher web page, comprising:
by the publisher web site, receiving an indication of a referral to the publisher web page from a search engine service based on an activation of one of a plurality of search results, wherein the referral indication includes an indication of a query processed by the search engine service and to which the plurality of search results are responsive; and
by the publisher web site, processing the received referral indication at least by causing the query indication to be provided to a system external to the publisher web site for determining characteristics of the publisher web page.

2. The method of claim 1, further comprising:
by the publisher web site, receiving an indication of supplemental content determined at least in part based on the provided query indication and, based thereon, causing the supplemental content to be displayed in association with the publisher web page content.

3. The method of claim 2, wherein:
the supplemental content includes advertising; and
processing at least the referral indication provided by the publisher web page includes determining the advertising.

4. The method of claim 1, further comprising:
by the system external to the publisher web site, determining characteristics of the publisher web page based at least in part on the provided query indication.

5. The method of claim 1, further comprising:
by the system external to the publisher web site, determining characteristics of the publisher web page based at least in part on the provided query indication and causing the determined characteristics to be provided for use by a search engine service.

6. A computer program product for use with a publisher web site in the process of a publisher web page being referred from a search engine service, the computer program product comprising at least one computer-readable medium having computer program instructions stored therein which are operable to cause at least one computing device to:
receive an indication of a referral from the search engine service based on an activation of one of a plurality of search results, wherein the referral indication includes an indication of a query processed by the search engine service and to which the plurality of search results are responsive; and
process the received referral indication at least by causing the query indication to be provided to a system external to the publisher web site for determining characteristics of the publisher web page.

7. The computer program product of claim 6, wherein the computer program instructions are further operable to cause the at least one computing device to:
receive an indication of supplemental content determined at least in part based on the provided query indication and, based thereon, cause the supplemental content to be displayed in association with the publisher web page content.

8. The computer program product of claim 7, wherein:
the supplemental content includes advertising; and
the computer program instructions operable to cause the at least one computing device to process at least the referral indication provided by the publisher web page includes computer program instructions operable to cause the at least one computing device to determine the supplemental content.

9. A computer program product for use a system external to a publisher web site in the process of a publisher web page being referred from a search engine service, the computer program product comprising at least one computer-readable medium having computer program instructions stored therein which are operable to cause at least one computing device to:
determining characteristics of the publisher web page based at least in part on a query indication provided from a publisher web site, wherein the publisher web site is configured to provide query indications based on an indication of a referral to the publisher web page from a search engine service based on an activation of one of a plurality of search results, wherein the referral indication includes an indication of the query processed by the search engine service and to which the plurality of search results are responsive; and
processing a web search query based at least in part on the determined characteristics of the publisher web page.

10. A computing system including at least one computing device, the at least one computing device configured to:
receive an indication of a referral from a search engine service based on an activation of one of a plurality of search results, wherein the referral indication includes an indication of a query processed by the search engine service and to which the plurality of search results are responsive;
process the received referral indication at least by causing the query indication to be provided to a system external to the web site for determining supplemental content to display in association with the web page content; and
display a publisher web page including displaying the determined supplemental content in association with web page content of the publisher web page.

11. The computing system of claim 10, wherein:
the at least one computing device is configured to process the received referral indication at least by causing the query indication to be provided to a system external to the web site as a result of the at least one computing device executing active code in association with processing data corresponding to display of the publisher web page.

12. The computing system of claim 11, wherein:
the active code is selected from a group consisting of Javascript code and ActiveX code.
